(19) United States
(12) Patent Application Publication
(10) Pub. No.: US 2004/0034519 A1
(43) Pub. Date: Feb. 19, 2004

(54) Dynamic language models for speech recognition

(76) Inventors: Serge Le Huitouze, Corps Nuds (FR); Frederic Soufflet, Chateaugiron (FR)

Correspondence Address: Joseph S Tripoli, Patent Operations, Thomson Multimedia Licensing Inc, CN 5312, Princeton, NJ, 08543-0028, US

(21) Appl. No.: 10/296,080

(22) PCT Filed: May 15, 2001
(86) PCT No.: PCT/FR01/01469

(30) Foreign Application Priority Data
May 23, 2000 (EP) 00401433.8

(51) Int. Cl. G06F 17/20

(52) U.S. Cl. 704/1

(57) ABSTRACT

The invention relates to a voice recognition process, comprising a step of voice recognition taking into account at least one grammatical language model (310) and implementing a decoding algorithm intended for identifying a set of words on the basis of a set of voice samples (201), said language model being associated with at least one dynamically developed finite or infinite state automaton (313).

The invention also relates to corresponding devices (102) and computer program products.

The present invention pertains to the field of voice recognition.

More precisely, the invention relates to large vocabulary voice interfaces. It applies in particular in the field of television.

Information or control systems are making ever increasing use of a voice interface to make interaction with the user fast and intuitive. Since these systems are becoming more complex, the dialogue styles supported must be ever more rich, and one is entering the field of large vocabulary continuous voice recognition.

It is known that the design of a large vocabulary continuous voice recognition system requires the production of a language model which defines or approximates acceptable strings of words, these strings constituting sentences recognized by the language model.

In a large vocabulary system, the language model therefore enables the voice processing module to construct the sentence (that is to say the set of words) which is most probable, in relation to the acoustic signal which is presented to it. This sentence must then be analyzed by a comprehension module so as to transform it into a series of appropriate actions (commands) at the level of the voice controlled system.

At present, two approaches are commonly used by language models, namely models of N-gram type and grammars.

In what follows consideration will be given to grammar-like language models, this not being limiting, since with voice applications becoming more complex, they need more and more highly expressive formalisims for the development of the language models.

According to the state of the art, the voice recognition systems using grammars compile them in the form of a finite state automaton.

It is this automaton which is used by the voice processing module to analyze the sets of words complying with the grammar.

Such an approach has the advantage of minimizing the apparent cost on execution, since the grammar is transformed once and for all before execution (by a compilation procedure) into an internal representation which is perfectly sized for the requirements of the voice processing module.

On the other hand, it has the drawback of constructing a representation (automaton) which may become highly memory consuming in the case of complex grammars, this possibly raising resource problems with regard to the executing computer system, and may even slow down execution if the invoking of the mechanism for paging the virtual memory of the execution system becomes too frequent.

Moreover, as indicated above, the grammars become more complex in terms of size and expressivity along with the generalization of voice controlled systems. This merely increases the size of the associated automaton and hence aggravates the drawbacks mentioned above.

An objective of the invention according to its various aspects is in particular to alleviate these drawbacks of the prior art.

More precisely, an objective of the invention is to provide a voice recognition system and process optimizing the use of the memory, in particular for large vocabulary applications.

The objective of the invention is also a reduction in the costs of implementation or of use.

A complementary objective of the invention is to provide a process allowing a saving of energy, in particular when the process is implemented in a device with a standalone energy source (for example an infrared remote control or a mobile telephone).

An objective of the invention is also an improvement in the speed of voice recognition.

With this aim, the invention proposes a voice recognition process, noteworthy in that it comprises a step of voice recognition taking into account at least one grammatical language model and implementing a decoding algorithm intended for identifying a set of words on the basis of a set of voice samples, the language model being associated with at least one dynamically developed finite or infinite state automaton.

It is noted that here, the finite state automaton or automata are developed dynamically as a function in particular of requirements, as opposed to statically developed automata which are developed in a complete manner, systematically.

It is also noted that the infinite automata may benefit from this technique since only a finite part of the automaton is developed.

According to a particular characteristic, the process is noteworthy in that it comprises a step of widthwise dynamic development of the automaton or automata on the basis of at least one grammar defining a language model.

According to a particular characteristic, the process is noteworthy in that it comprises a step of constructing at least one part of an automaton comprising at least one branch, each branch comprising at least one node, the construction step comprising a substep of selective development of the node or nodes, according to a predetermined rule.

Thus, preferably, the process does not allow the systematic development of all the nodes but selectively according to a predetermined rule.

According to a particular characteristic, the process is noteworthy in that the algorithm comprises a step of requesting development of at least one nondeveloped node allowing development of the node or nodes according to the predetermined rule.

Thus, the process advantageously allows the development of the nodes requested by the algorithm itself as a function of its requirements, related in particular to the incoming acoustic information. Thus, if a pass through an undeveloped given node is unlikely, the algorithm will not request the development of this node. On the other hand, a likely pass through this node will give rise to its development.

According to a particular characteristic, the process is noteworthy in that according to the predetermined rule, for each branch, each first node of the branch is developed.

Thus, advantageously, the process systematically authorizes the development of the first node of each branch emanating from a developed node.

According to a particular characteristic, the process is noteworthy in that for at least one branch comprising a first node and at least one node following the first node, the construction step comprises a substep of replacing the following node or nodes by a nondeveloped special node.

Thus, the process advantageously only allows developments of necessary nodes, thus saving on the resources of a device implementing the process.

According to a particular characteristic, the process is noteworthy in that the decoding algorithm is a maximum likelihood decoding algorithm.

Thus, the process is advantageously compatible with a maximum likelihood algorithm, such as in particular the Viterbi algorithm thus allowing reliable voice recognition of reasonable implementational complexity, in particular in the case of large vocabulary applications.

The invention also relates to a voice recognition device, noteworthy in that it comprises voice recognition means taking into account at least one grammatical language model and implementing a decoding algorithm intended for identifying a set of words on the basis of a set of voice samples, the language model being associated with a dynamically developed finite or infinite state automaton.

The invention relates, furthermore, to a computer program product comprising program elements, recorded on a medium readable by at least one microprocessor, noteworthy in that the program elements control the microprocessor or microprocessors so that they perform a step of voice recognition taking into account at least one grammatical language model and implementing a decoding algorithm intended for identifying a set of words on the basis of a set of voice samples, the language model being associated with a dynamically developed finite or infinite state automaton.

The invention relates, also, to a computer program product, noteworthy in that the program comprises sequences of instructions tailored to the implementation of the voice recognition process as described above when the program is executed on a computer.

The advantages of the voice recognition device, and of the computer program products are the same as those of the voice recognition process, they are not detailed more fully.

Other characteristics and advantages of the invention will be more clearly apparent on reading the following description of a preferred embodiment, given by way of simple and nonlimiting illustrative example, and of the appended drawings, among which:

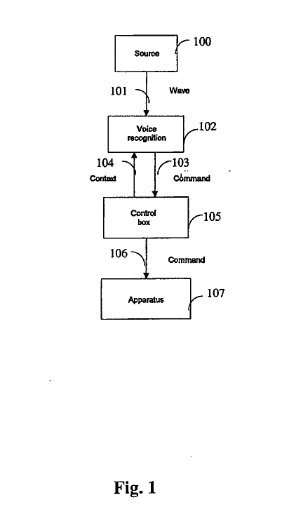

FIG. 1 depicts a general schematic of a system comprising a voice command box, in which the technique of the invention is implemented;

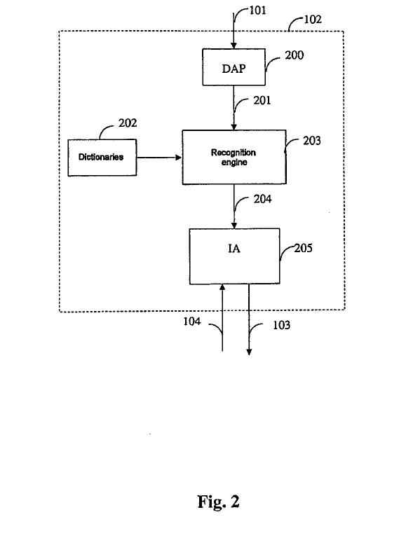

FIG. 2 depicts a schematic of the voice recognition box of the system of FIG. 1;

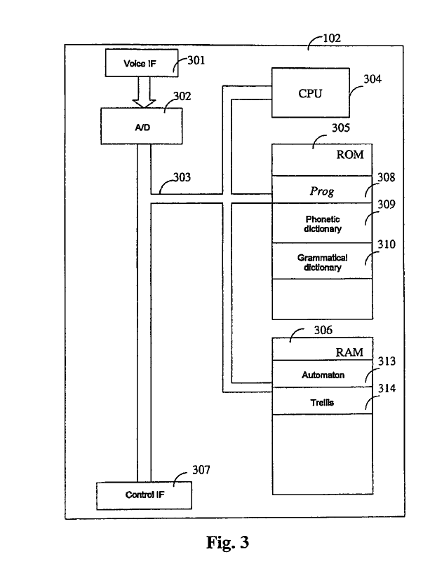

FIG. 3 describes an electronic layout of a voice recognition box implementing the schematic of FIG. 2;

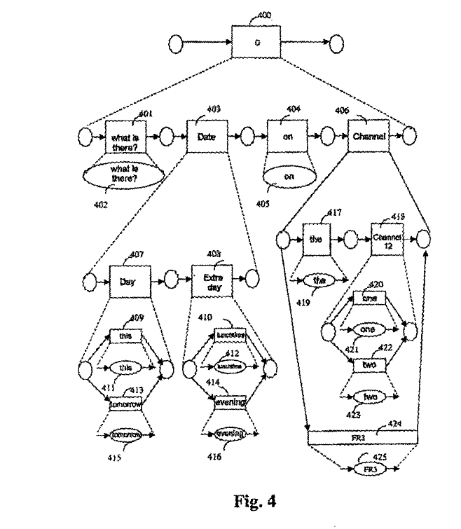

FIG. 4 describes a static voice recognition automaton, known per se;

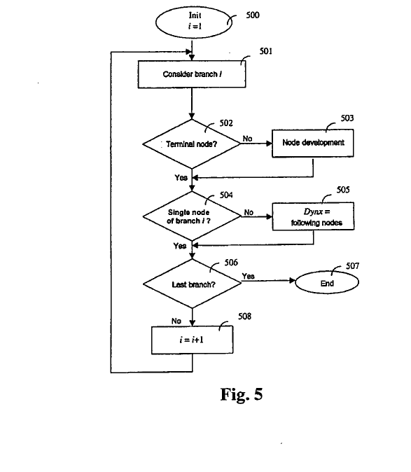

FIG. 5 depicts an algorithm for dynamic widthwise development of a node implemented by the box of FIGS. 1 and 3;

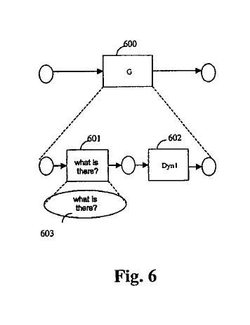

FIGS. 6 to 10 illustrate requests for development of a dynamic voice recognition network, according to the algorithm of FIG. 5.

Returning to the standard manner of operation of a voice processing module, it is found that for a given acoustic input, only a tiny subset of the automaton representing the language model is explored, owing to the considerable pruning carried out by the voice processing module. Specifically, out of all the words which are grammatically acceptable at a given step of the calculation, the very great majority will be disqualified, owing to the overly great phonetic-acoustic difference with the signal entering the system.

Starting from this finding, the general principle of the invention is based on replacing the representation in the form of a statically calculated automaton with a dynamic representation allowing the progressive development of the grammar, this making it possible to solve the size problem.

Thus, the invention consists in using a representation making it possible to develop the commencements of sentences progressively.

Intuitively, this amounts to replacing an extension-based representation of the automaton (that is to say one which enumerates all its states) associated with the grammar, with an “intension”-based representation, that is to say a representation which enables those parts of the automaton which are potentially of interest in the remainder of the recognition procedure to be calculated as and when required.

The programming techniques which make it possible to utilize this representation by “intension” are based, for example, on:

techniques of searching for shorter paths in graphs, (described in particular in the work “Graphes et Algorithmes” [Graphs and Algorithms], written by Michel Gondran and Michel Minoux and published in 1990 by Eyrolles);

lazy evaluation techniques used in compilers for functional languages (such as described in the book “The Implementation of Functional Programming Languages” or, in French “l'implémentation des langages de programmation fonctionnelles”, written by Simon Peyton Jones and published in 1987 by Prentice Hall International Series on Computer Science); as well as

known techniques of automatic proof such as “structure-sharing” (a description of which will be found in the book “Principles of Artificial Intelligence” or, in French “les principes de l'intelligence artificielle”, written by Nils Nilsson and published in 1980 by Springer-Verlag).

A general schematic of a system comprising a voice command box 102 implementing the technique of the invention is depicted in conjunction with FIG. 1.

It is noted that this system comprises in particular:

a voice source 100 which can in particular consist of a microphone intended to pick up a voice signal produced by a speaker;

a voice recognition box 102;

a control box 105 intended to operate an apparatus 107;

a controlled apparatus 107, for example of television or video recorder type.

The source 100 is connected to the voice recognition box 102, via a link 101 which enables it to transmit an analogue source wave representative of a voice signal to the box 102.

The box 102 can retrieve context information 104 (such as for example, the type of apparatus 107 which can be driven by the control box 105 or the list of command codes) via a link 104 and send commands to the control box 105 via a link 103.

The control box 105 sends commands via a link 106, for example, infrared, to the apparatus 107.

According to the embodiment considered the source 100, the voice recognition box 102 and the control box 105 form part of one and the same device and thus the links 101, 103 and 104 are internal links within the device. On the other hand, the link 106 is typically a wireless link.

According to a first variant embodiment of the invention described in FIG. 1, the elements 100, 102 and 105 are partly or completely separate and do not form part of one and the same device. In this case, the links 101, 103 and 104 are external wire links or otherwise.

According to a second variant, the source 100, the boxes 102 and 105 and the apparatus 107 form part of one and the same device and are connected together by internal buses (links 101, 103, 104 and 106). This variant is especially beneficial when the device is, for example, a telephone or a portable telecommunication terminal.

FIG. 2 depicts a schematic of a voice command box such as the box 102 illustrated in conjunction with FIG. 1.

It is noted that the box 102 receives from outside the analogue source wave 101 which is processed by an Acoustic-Phonetic Decoder 200 or APD (possibly referred to simply as a “front-end”). The APD 200 samples the source wave 101 at regular intervals (typically every 10 ms) so as to produce real vectors or vectors belonging to code books, typically representing oral resonances which are transmitted via a link 201 to a recognition engine 203.

It is recalled that an acoustic-phonetic decoder translates the digital samples into acoustic symbols chosen from a predetermined alphabet.

A linguistic decoder processes these symbols with the aim of determining, for a sequence A of symbols, the most probable sequence W of words, given the sequence A. The linguistic decoder comprises a recognition engine using an acoustic model and a language model. The acoustic model is for example a so-called “Hidden Markov Model” or HMM. It calculates in a manner known per se the acoustic scores of the word sequences considered. The language model implemented in the present exemplary embodiment is based on a grammar described with the aid of syntax rules of Backus Naur form. The language model is used to determine a plurality of assumptions of sequences of words and to calculate linguistic scores.

The recognition engine is based on a Viterbi type algorithm referred to as “n-best”. The n-best type algorithm determines at each step of the analysis of a sentence the n sequences of words which are most probable. At the end of the sentence, the most probable solution is chosen from among the n candidates, on the basis of the scores supplied by the acoustic model and the language model.

The manner of operation of the recognition engine is now described more especially. As mentioned, the latter uses a Viterbi type algorithm (n-best algorithm) to analyze a sentence composed of a sequence of acoustic symbols (vectors). The algorithm determines the N sequences of words which are most probable, given the sequence A of acoustic symbols which is observed up to the current symbol. The most probable sequences of words are determined through the stochastic grammar type language model. In conjunction with the acoustic models of the terminal elements of the grammar, which are based on HMMs (“Hidden Markov Models”), a global hidden Markov model is then produced for the application, which therefore includes the language model and for example the phenomena of coarticulations between terminal elements. The Viterbi algorithm is implemented in parallel, but instead of retaining a single transition to each state during iteration i, the N most probable transitions are retained for each state.

Information relating in particular to the Viterbi algorithm, beam search algorithm and “n-best” algorithm are given in the work:

“Statistical methods for speech recognition” by Frederik Jelinek, MIT press 1999 ISBN 0-262-10066-5 chapters 2 and 5 in particular.

The analysis performed by the recognition engine is halted when all the acoustic symbols relating to a sentence have been processed. The recognition engine then has available a trellis consisting of the states at each previous iteration of the algorithm and of the transitions between these states, up to the final states. Ultimately, the N most probable transitions are retained from among the final states and their N associated transitions. By retracing the transitions from the final states, the N most probable sequences of words corresponding to the acoustic symbols are determined. These sequences are then subjected to processing using a parser with the aim of selecting the single final sequence on grammatical criteria.

Thus, with the aid of dictionaries 202, the recognition engine 203 analyzes the real vectors which it receives, using in particular hidden Markov models or HMMs and language models (which represent the probability of one word following another word) according to a Viterbi algorithm with dynamic widthwise development of the states which is detailed hereinbelow.

The recognition engine 203 supplies the words which it has identified on the basis of the vectors received to a means for translating these words into commands which can be understood by the apparatus 107. This means uses an artificial intelligence translation process which itself takes into account a context 104 supplied by the control box 105 before transmitting one or more commands 103 to the control box 105.

FIG. 3 diagrammatically illustrates a voice recognition module or device 102 such as illustrated in conjunction with FIG. 1, and implementing the schematic of FIG. 2.

The box 102 comprises connected together by an address and data bus:

a voice interface 301;

an analogue-digital converter 302;

a processor 304;

a nonvolatile memory 305;

a random access memory 306; and

an apparatus control interface 307.

Each of the elements illustrated in FIG. 3 is well known to the person skilled in the art. These commonplace elements are not described here.

It is observed moreover that the word “register” used throughout the description designates in each of the memories mentioned, both a memory area of small capacity (a few data bits) and a memory area of large capacity (making it possible to store an entire program or the whole of a sequence of transaction data).

The nonvolatile memory 305 (or ROM) holds in registers which for convenience possess the same names as the data which they hold:

the program for operating the processor 304 in a “prog” register 308; and

a phonetic dictionary of the words which are to be understood by the recognition engine in a register 309; and

a grammatical dictionary of the non-terminal nodes, said dictionary being used by the recognition engine to construct automata, in a register 310.

The random access memory 306 holds data, variables and intermediate results of processing and comprises in particular:

an automaton 313; and

a representation of a trellis 314.

FIG. 4 illustrates a static voice recognition automaton, known per se, which makes it possible to describe a Viterbi trellis used for voice recognition.

According to the state of the art, the whole of this trellis is taken into account. For the sake of clarity, a model of small size is considered, this corresponding to the recognition of a question related to the television channel program. Thus, it is assumed that a voice control box has to recognize a sentence of the type “what is there on a certain date on a certain television channel?”.

The corresponding automaton, according to the state of the art, is developed in extenso according to FIG. 4 and comprises:

nodes represented in a rectangular form, which are expanded; and

terminal nodes in an elliptical form, which are not expanded and which correspond to a word or an expression from everyday language.

Thus, the base node 400 “G” is expanded into four nodes 401, 403, 404 and 406, in accordance with the rule of grammar:

<G>=what is there <Date> on <Channel>

There is just one possibility for nodes 401 and 404 which therefore correspond to terminal nodes 402 (“what is there”) and 405 (“on”).

On the other hand, node 403 (“Date”) is developed into two nodes 407 (“day”) and 408 (“Extra Day”) which are themselves expanded according to an alternative 409 (“this”) and 413 (“tomorrow”) respectively for the day and 410 (“lunchtime”) and 411 (“evening”) for the extra one according to the rules:

<Date>=<Day> <Extra Day>

<Day>=this|tomorrow

<Extra Day>=lunchtime|evening

Thus, the date can be decoded according to four possibilities: “this lunchtime”, “this evening”, “tomorrow lunchtime” and “tomorrow evening”.

Likewise, node 406 (“Channel”) is developed as one alternative:

two successive nodes 417 (“the”) corresponding to a terminal node 419 and 418 (“Channel12”) which is itself expanded according to an alternative comprising nodes 420 (“one”) and 422 (“two”) associated with the terminal nodes 421 and 423 respectively; or

a node 424 (“FR3”) which corresponds to a terminal node 425; in accordance with the rules:

<Channel>=the <Channel12>|FR3

<Channel12>=one|two

It may be noted that this automaton, although corresponding to a small-size model, comprises numerous developed states and leads to a Viterbi trellis which already requires a memory and computational resources which are appreciable relative to the size of the model (it is noted that the size of the trellis grows with the number of states of the automaton).

According to the invention, an entirely statically calculated automaton is replaced with an automaton calculated as required by the Viterbi algorithm which seeks to determine the best path within this automaton. This is dubbed “dynamic widthwise development”, since the grammar is developed on all fronts deemed of interest with respect to the incoming acoustic information.

Thus, FIG. 5 describes an algorithm for dynamic widthwise development of a node which can be expanded according to the invention. This algorithm is implemented by the processor 304 of the device or voice recognition module 102 as illustrated in conjunction with FIG. 3.

This algorithm is applied to the nodes to be developed (such as chosen by the Viterbi algorithm) in a recursive manner so as to form an automaton comprising a developed node as base, until all the immediate successors are labeled by a Markovian model, that is to say it is necessary to recursively develop all the non-terminals in the left part of an automaton (assuming that the automaton is constructed from left to right, the first element of a branch therefore being situated on the left).

To construct the necessary portions of the automaton which emanate from the development of a node, the processor 304 dynamically uses:

the dictionary 310 associated with the non-terminal nodes (which makes it possible to obtain their definition); and

the dictionary 309 associated with the words (which makes it possible to obtain their HMM).

It is noted that that such dictionaries are known per se since they are also used in the static construction of complete automata according to the state of the art.

Thus, according to the invention, the special nodes introduced (called “DynX” in the figures) also make reference to portions of definitions of the dictionary and are expanded to the strict minimum of requirements.

According to the algorithm for developing a node, in the course of a first step 500, the processor 304 initializes working variables related to the consideration of the relevant node, and in particular a branch counter i.

Next, in the course of a step 501, the processor 304 considers the i^{th} branch emanating from a first development of the relevant node, which becomes the active branch to be developed.

Thereafter, in the course of a test 502, the processor 304 determines whether the first node of the active branch is a terminal node.

If it is not, in the course of a step 503, the processor 304 develops the first node of the active branch, based on the algorithm defined in conjunction with FIG. 5 according to a recursive mechanism.

If the result of the test 502 is positive or following step 503, in the course of a test 504, the processor 304 determines whether the active branch comprises a single node.

If it does not, the processor 304 groups the following nodes of branch i into a single special node Dynx which will not be developed subsequently unless necessary. The execution of the Viterbi algorithm may indeed lead to this branch being eliminated, the probability of occurrence associated with the first node of the branch (manifested by the node metric in the trellis developed from the automaton) possibly being too small relative to one or more alternatives. Thus, in this case, the development of the special node Dynx is not performed thereby making it possible to save microprocessor CPU computation time and memory.

If the result of the test 504 is positive or following step 505, in the course of a test 506, the processor 304 determines whether the active branch is the last branch emanating from the first development of the relevant node.

If it is, in the course of a step 507, the algorithm for developing a node comes to an end.

If it is not, in the course of a step 508, the branch counter i is incremented by one unit and step 501 is repeated.

By way of example, this algorithm is applied to an acoustic input corresponding to the sentence “what is there this lunchtime on FR3?” with the following grammar:

<G>=what is there <Date> on <Channel>

<Date>=<Day> <ExtraDay>

<Day>=this|tomorrow

<ExtraDay>=lunchtime|evening

<Channel>=the <Channel12>|FR3

<Channel12>=one|two

Assuming that the acoustic models are fine enough to differentiate all the words of the grammar, the successive requests for dynamic development of the Viterbi algorithm will lead to the successive states of the dynamic automaton which are described in FIGS. 6 to 10.

Thus, according to the invention, the automaton will construct itself gradually, in tandem with the requests of the Viterbi algorithm.

It is noted that, when the Viterbi algorithm requests a dynamic development from a state of the automaton, the development must be continued until all the immediate successors are labeled by a Markovian model, that is to say it is necessary to recursively develop all the non-terminals in the left part (example: in FIG. 3, the development of <Date> is obviously necessary, but that of <Day> is also necessary so as to make the words “this” and “tomorrow” visible).

FIG. 6 depicts the automaton emanating from the application to a first base node “G” 600, of the algorithm for developing a node depicted in conjunction with FIG. 5, according to the invention.

It is noted that the node “G” 600 is decomposed as a single branch.

The first node “what is there” 601 of this branch is a terminal node. It is therefore associated directly with the corresponding expression 603.

The branch contains at least one other node according to the grammar describing this node. This branch will therefore be represented in the form of a first node and of a special node Dyn1 which is not developed.

Node 600 is decomposed as a single branch. The development of node 600 is therefore terminated.

To summarize, the automaton thus constructed is defined, according to the formalism used previously, in the following manner:

<G>=what is there <Dyn1>

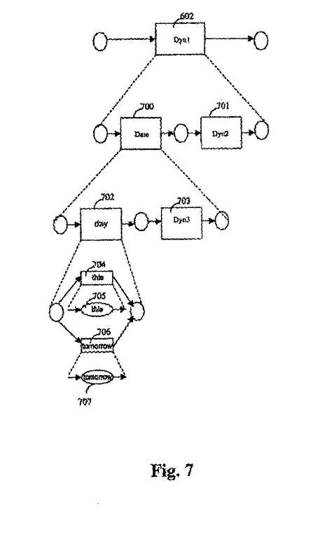

FIG. 7 depicts the automaton emanating from the application to the special node Dyn1 602, of the algorithm for developing a node depicted in conjunction with FIG. 5, according to the invention.

With the Viterbi algorithm considering the start of sentence “what is there” as likely, it will require the development of node 602.

It is noted that node 602 is decomposed as a single branch.

The first node “Date” 700 of this branch is not a terminal node. It is therefore developed recursively according to the development algorithm illustrated in conjunction with FIG. 5.

Node 700 is decomposed as a single branch.

The first node “Day” 702 of this branch is not a terminal node. It is therefore likewise developed.

Node 702 is decomposed as two branches symbolizing an alternative.

The first node of each of these two branches “this” 704 and “tomorrow” 706 respectively is a terminal node. It is therefore associated directly with the corresponding expression 705 and 707 respectively.

With these branches containing just a single node, the development of node 702 is terminated.

The branch emanating from the node “Date” 703 containing more than one node, it is decomposed as the developed node “Day” 702 and as a special node Dyn3 703.

Likewise, the branch emanating from the node Dyn1 602 containing more than one node, it is decomposed as the developed node “Date” 700 and as a special node, Dyn2 701.

The development of node 600 is terminated in this way and, to summarize, the automaton emanating from the node 600 thus constructed is defined, according to the formalism used previously, in the following manner:

<Dyn1>=<Date> <Dyn2>

<Date>=<Day> <Dyn3>

<Day>=this|tomorrow

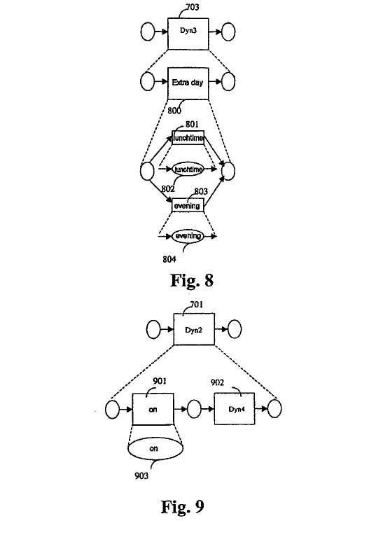

FIG. 8 depicts the automaton emanating from the application to the special node Dyn3 703, of the algorithm for developing a node depicted in conjunction with FIG. 5, according to the invention.

With the Viterbi algorithm considering the start of sentence “what is there this” as likely, it will require the development of node 703.

It is noted that node 703 is decomposed as a single branch.

The single node “Extra Day” 800 of this branch is not a terminal node. It is therefore developed recursively according to the development algorithm illustrated in conjunction with FIG. 5.

Node 800 is decomposed as two branches symbolizing an alternative.

The single node of each of these two branches “lunchtime” 801 and “evening” 804 respectively is a terminal node. It is therefore associated directly with the corresponding expression 802 and 804 respectively.

With these branches containing just a single node, the development of node 703 is terminated and, to summarize, the automaton emanating from node 703 thus constructed is defined, according to the formalism used previously, in the following manner:

<Dyn3>=<Extra Day>

<Extra Day>=lunchtime|evening

FIG. 9 depicts the automaton emanating from the application to the special node Dyn2 701, of the algorithm for developing a node depicted in conjunction with FIG. 5, according to the invention.

With the Viterbi algorithm considering the start of sentence “what is there this lunchtime” as likely, it will require the development of node 703.

Node 701 is decomposed as a single branch.

The first node “on” 901 of this branch is a terminal node. It is therefore associated directly with the corresponding expression 903.

With the branch containing more than one node, it is decomposed as the developed terminal node “on” 901 and as a special node Dyn4 704.

The development of node 701 is terminated in this manner and, to summarize, the automaton emanating from the node 701 thus constructed is defined, according to the formalism used previously, in the following manner:

<Dyn2>=on <Dyn4>

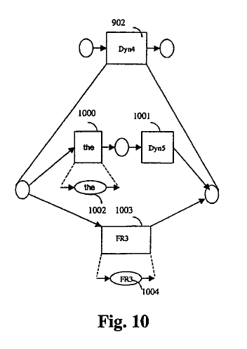

FIG. 10 depicts the automaton emanating from the application to the special node Dyn4 902, of the algorithm for developing a node depicted in conjunction with FIG. 5, according to the invention.

With the Viterbi algorithm considering the start of sentence “what is there this lunchtime on” as likely, it will require the development of node 902.

Node 902 is decomposed as two branches symbolizing an alternative.

The first node of each of these two branches “the” 1000 and “FR3” 1004 respectively is a terminal node. It is therefore associated directly with the corresponding expression 1002 and 1004 respectively.

The first branch emanating from node Dyn4 902 containing more than one node, it is decomposed as the node “the” 1000 and as a special node Dyn5 1001.

The second branch containing just a single node, the development of the node 600 is terminated in this manner and, to summarize, the automaton emanating from node 902 thus constructed is defined, according to the formalism used previously, in the following manner:

<Dyn4>=the <Dyn5>|FR3

According to the example, if the acoustic input corresponds to the sentence “what is there this lunchtime on FR3”, the Viterbi algorithm eliminates the possibility of having the word “the” corresponding to the terminal node 1002, its probability of occurrence being very small relative to the alternative represented by the terminal node “FR3”. It would not therefore request the development of the special node Dyn5 1001 which follows the node “the” 1002 on the same branch.

It is noted that the expansion of the automaton is thus limited as a function of the incoming acoustic data. According to the example described, the vocabulary is relatively narrow for reasons for clarity, but, it is clear that the difference in size between a dynamically constructed automaton and a static automaton grows as a function of the width of the vocabulary.

Of course, the invention is not limited to the exemplary embodiments mentioned hereinabove.

In particular, the person skilled in the art will be able to introduce any variant into the dynamic widthwise development and in particular into the determination of the cases where a special node is inserted into an automaton. Specifically, numerous variants for this insertion are possible between the two extreme cases, namely the embodiment of the invention described in FIG. 5 (a node is developed only when necessary), on the one hand, and the static case of the state of the art, on the other hand.

Likewise, the voice recognition process is not limited to the case where a Viterbi algorithm is implemented but to all algorithms using a Markov model, in particular in the case of algorithms based on trellises.

It is also noted that the invention is not limited to a purely hardware installation but that it can also be implemented in the form of a sequence of instructions of a computer program or any form which mixes a hardware part and a software part. In the case where the invention is installed partially or totally in software form, the corresponding sequence of instructions may be stored in a removable storage means (for example a diskette, a CD-ROM or a DVD-ROM) or otherwise, this storage means being partially or totally readable by a computer or a microprocessor

1. A voice recognition process, characterized in that it comprises a step of voice recognition taking into account at least one grammatical language model (310) and implementing a decoding algorithm intended for identifying a set of words on the basis of a set of voice samples (201), said language model being associated with at least one dynamically developed finite or infinite state automaton (313).

2. The process as claimed in claim 1, characterized in that it comprises a step of widthwise dynamic development of said automaton or automata on the basis of at least one grammar (310) defining a language model.

3. The process as claimed in claim 2, characterized in that it comprises a step of constructing at least one part of an automaton comprising at least one branch, each branch comprising at least one node, said construction step comprising a substep of selective development of said node or nodes, according to a predetermined rule.

4. The process as claimed in claim 3, characterized in that said algorithm comprises a step of requesting development of at least one nondeveloped node allowing development of said node or nodes according to said predetermined rule.

5. The process as claimed in any one of claims 3 and 4, characterized in that, according to said predetermined rule, for each branch, each first node of said branch is developed (503).

6. The process as claimed in any one of claims 3 to 5, characterized in that, for at least one branch comprising a first node and at least one node following said first node, said construction step comprises a substep of replacing said following node or nodes by a nondeveloped special node (505).

7. The process as claimed in any one of claims 1 to 6, characterized in that said decoding algorithm is a maximum likelihood decoding algorithm.

8. A voice recognition device (102), characterized in that it comprises voice recognition means (203) taking into account at least one grammatical language model (202) and implementing a decoding algorithm intended for identifying a set of words on the basis of a set of voice samples (201), said language model being associated with a dynamically developed finite or infinite state automaton (313).

9. A computer program product comprising program elements, recorded on a medium readable by at least one microprocessor, characterized in that said program elements control the microprocessor or microprocessors so that they perform a step of voice recognition taking into account at least one grammatical language model and implementing a decoding algorithm intended for identifying a set of words on the basis of a set of voice samples, said language model being associated with a dynamically developed finite or infinite state automaton.

10. A computer program product, characterized in that said program comprises sequences of instructions tailored to the implementation of a voice recognition process as claimed in any one of claims 1 to 7 when said program is executed on a computer.
